(19) United States
(12) Patent Application Publication
(10) Pub. No.: US 2011/0155171 A1
(43) Pub. Date: Jun. 30, 2011

(54) Cleaning and Conditioning Cloth

(76) Inventors: Chunlei HUANG, Bedford, MA (US); Lei ZHU, Bedford, MA (US)

(21) Appl. No.: 12/959,617

(22) Filed: Dec. 3, 2010

Related U.S. Application Data
(63) Continuation-in-part of application No. 12/647,248, filed on Dec. 24, 2009.

(51) Int. Cl. B08B 1/00

(52) U.S. Cl. 134/6; 15/104.93

(57) ABSTRACT

A cleaning and conditioning cloth for an ice skate, including hockey and speed skates, as well as other objects, includes a rectangular body, or a body selected from one of other various shapes such as circle, square, and diamond, of cut-resistant, water-absorbent fabric and an oil impregnated fabric affixed to the approximate center of the cleaning and conditioning cloth body wherein the method includes the steps of holding the cleaning and conditioning cloth in one hand and the ice skate in the other, placing the blade of the ice skate in the middle of the oil impregnated fabric, and moving the ice skate and the cleaning and conditioning cloth relative to each other, so that the blade moves from the cleaning and conditioning cloth body to the oil impregnated fabric. The body and the oil impregnated fabric may be of various sizes.

### DESCRIPTION RELATIVE TO THE PRIOR ART

The present device and method relates to the field of the cleaning and conditioning of various metal objects, including ice skates, hockey skates and speed skates, ski edges, snow board edges, sled runners, knives, and fishing rods.

This present device and method is more specifically applicable to maintenance of the objects by cleaning and drying the various objects subsequent to use, and conditioning them by applying oil or wax, thereby preventing corrosion of the metal.

The device and method were first applied to ice skate blades, which become wet when used, and whereby the blades may corrode if not immediately dried after use. The cloth of the present device and method is of a non-abrasive type, so that the sharp edge of the blade is not dulled by drying and conditioning.

Other metal objects have similar characteristics and benefit in the same as do ice skate blades. These other metal objects include ski edges, snow board edges, sled runners, knives, fishing rods, guns and golf clubs. Although fishing rods do not have sharp edges as to the other objects listed above, they also benefit from the application of oil or wax with the present device, since corrosion is inhibited thereby.

A typical ice skate is shown in FIG. 1, the skate comprising a body 1 and blade 3.

In the use of the ice skates, the blades are generally various varieties stainless steel, or other types of corrosion resistant steels, although other materials, such as aluminum and titanium, also exist in the prior art. Nevertheless, many of the blade materials used in the manufacture of ice skates are generally subject to corrosion.

During skating, both pressure and friction between the skate blades and the ice create the water lubricant required for skating. In addition, the ice is scraped into a slush or “snow” by the ice skate blades as a result of the various maneuvers common to ice skating. In particular the techniques used in stopping invariably create such “snow”, which accumulates on the blades. If left on the blades, the “snow” results in some corrosion, which dulls the blades, among other problems. The general solution to such corrosion has been to sharpen the blades when corrosion occurs. This can be both expensive and time consuming.

One solution to the accumulation of water on the skate blades has been to use “soakers” on the skate blades after use. FIG. 2 shows an example of a “soaker”, fitted about the blade of a skate. These are generally made of a soft, absorbent fabric, such as terry cloth. They are generally kept on the skate blades when the blades are not in use.

It has been found that the use of “soakers” does not completely prevent the development of corrosion on the surface of the skate blades as water, dust and rust accumulate inside the soaker overtime.

Another solution is to wipe off snow by a towel. However, a towel may become wet, dirty and/or impregnated with rust. A wet, dirty and rusty towel may cause more damage to the blades.

One method found to be effective for preventing corrosion is the application of oil on the skate blade. Various types of oil, including anti rust, anti corrosion, natural and synthetic, can be used, as well as vegetable oil of the type used for cooking. However, applying oil from an oil can has been found to be awkward and messy. The best protection requires applying oil immediate after each skating event when skates are not in use. Carrying an oil can or container is not convenient. Furthermore, it has been found that applying oil from an oil can or vegetable oil bottle onto the surface of the skate blades has resulted in a substantial amount of waste in the application, especially since the most effective placement of the oil is on the edges of the blade, where accumulation of corrosion is the most troubling.

The present device and method provides a simple, clean, inexpensive, and environment friendly way of applying the oil, reducing the amount of waste and eliminating oil on the hands of the user.

### SUMMARY OF THE DEVICE AND METHOD

It is an objective of the present device and method to provide a device and means for preventing corrosion on the blades of ice skates and other metal objects.

In accordance with one aspect of the device and method, a cleaning and conditioning cloth includes a, body of cut-resistant, water-absorbent fabric, and a piece of oil-impregnated fabric, affixed to the approximate center of the body.

In accordance with a second aspect of the device and method the piece of oil-impregnated fabric may be removably affixed to the center of the rectangular body, and may have a square, rectangular, circular, or other shape.

In accordance with a third aspect of the device and method the oil used is anti rust, anti corrosion, natural or synthetic, semi-synthetic oil, wax, or vegetable oil.

In accordance with a fourth aspect of the device and method the piece of oil-impregnated fabric is square, circular, diamond-shaped, or having other shapes.

In accordance with a fifth aspect of the device and method, the cleaning and conditioning cloth is used by the steps of holding it in one hand and the ice skate in the other, placing the blade of the ice skate in the middle of the oil impregnated fabric, and moving the ice skate and the cleaning and conditioning cloth relative to each other.

In accordance with a sixth aspect of the device and method the blade moves from the cleaning and conditioning cloth body to the oil impregnated fabric.

In accordance with a seventh aspect of the device and method, the user moves the blade away from the cleaning and conditioning cloth body after it passes through the oil-permeated fabric.

In accordance to an eighth aspect of the device and method, the user can apply oil to the skate blade by other methods, such as but not limited to a brush, spread and sponge.

In accordance to a ninth aspect of the device and method, the oil-impregnated fabric can be used in combination with a water absorbent fabric without impregnated oil for better results.

In accordance to a tenth aspect of the device and method, the whole device can be made from recycled materials and collected after use for reprocess and then reuse.

In accordance with an eleventh aspect of the device and method the cleaning and conditioning cloth includes a first layer comprising a cut-resistant, non-abrasive, low lint, water-absorbent and oil-absorbent material, a second layer comprising oil-embedded material; and a third layer, disposed between the first and second layers, comprised of a material that prevents contamination between the first and second layers.

In accordance with a twelfth aspect of the device and method the third layer is affixed on one surface to the first layer, and on an opposite surface to the second layer, forming a single cloth thereby.

In accordance with a thirteenth aspect of the device and method cleaning any one of the members of a group which consists of ice skate blades, ski edges, snow board edges, sled runners, knives, fishing rods, guns and golf clubs.

In accordance with a fourteenth aspect of the device and method the oil sheet can be same size as body of the other layers.

In accordance with a fifteenth aspect of the device and method the oil sheet is back coated with other material to prevent the oil from further penetrating through other sheets.

### BRIEF DESCRIPTION OF THE DRAWINGS

Other characteristics of the device and method will become apparent from a description thereof for preventing corrosion on the blades of ice skates and other objects with reference to, but not limited to, embodiments described below; in which

FIG. 1 depicts a perspective view of a prior art ice skate.

FIG. 2 depicts a perspective view of a prior art ice skate with a “soaker” covering the blade.

FIG. 3 depicts a cleaning and conditioning cloth in accordance with the present device and method.

FIG. 4 depicts a perspective view of the cleaning and conditioning cloth of the present device and method in use.

FIG. 5 depicts a top plan view of a prior art ski

FIG. 5A depicts a side elevation view of the ski of FIG. 5.

FIG. 6 depicts a three-layer embodiment of the present device.

FIG. 6A depicts the top layer of the device of FIG. 6.

FIG. 6B depicts the middle layer of the device of FIG. 6.

FIG. 6C depicts the bottom layer of the device of FIG. 6.

FIG. 7 depicts a perspective view of a user cleaning a ski edge using the cloth cleaning device.

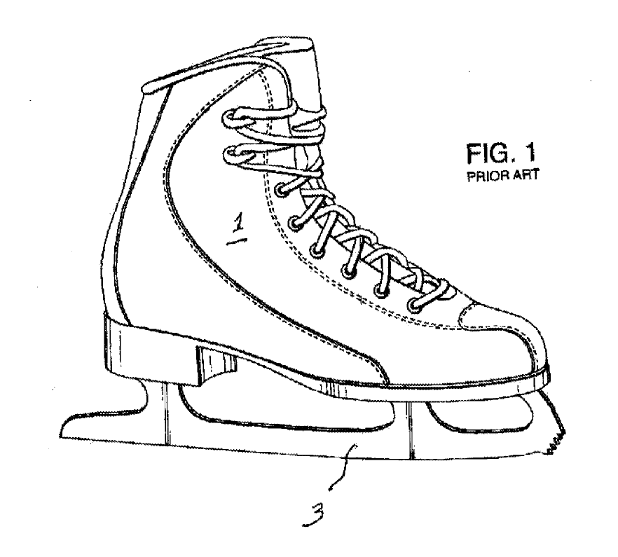

### DETAILED DESCRIPTION

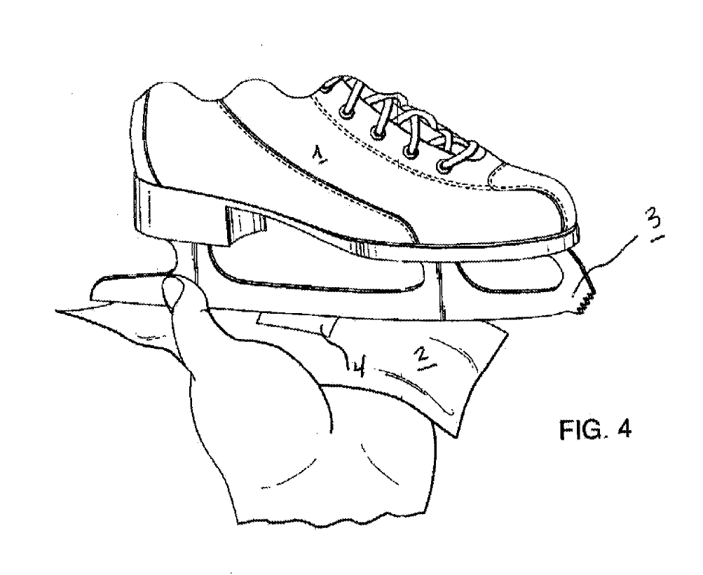

Referring now to FIG. 4, a cleaning and conditioning cloth of the present device and method is shown. The device includes a body 2, which is formed of a sheet of an absorbent material, such as cotton, paper, leather, wool, terry cloth, or any of several synthetic or recycled materials. In particular, a cut-resistant fabric is included in the first embodiment.

Referring next to FIG. 4, a user is applying the cleaning and conditioning cloth to a skate blade 3. It may be seen that the front and back of the blade is being wiped by the body 2 of the cleaning and conditioning cloth, while the middle of the blade is in contact with the oil-bearing center portion of the cleaning and conditioning cloth.

An example of such a cut-resistant fiber is made of high tenacity, high modulus polyethylene fiber, available from Ningbo Dacheng Advanced Material Co., Ltd, Zhejiang, China. Why do we need to mention this specific company? This material is woven by special high-density knitting machines. Other fabrics may be used. The requirements of this cleaning and conditioning cloth body include (1) the ability to absorb water, and (2) resistance to cutting.

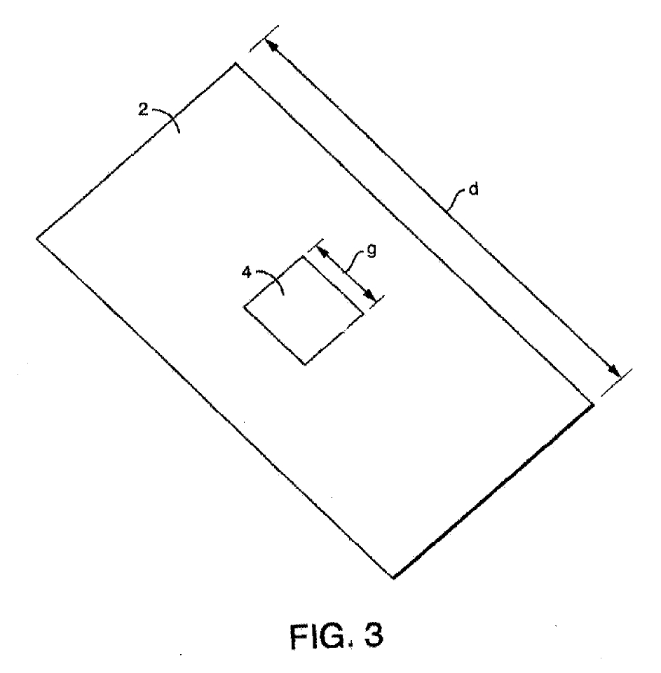

Referring now to FIG. 3, it may be seen that the body 2 of the cleaning and conditioning cloth is rectangular in configuration, approximately between 4 and 18 inches in length d, and between 2 and 12 inches in width. In other embodiments the body may have other shapes. As just described, it is made of a flexible, cut-resistant material with good water-absorption properties.

In the first embodiment the oil square 4, a piece of fabric impregnated with oil, has an approximate width g of 2 inches and a length of 2 inches. This material can be same as or different from the material made of the body 2. The oil square 4 has an adhesive backing so that it will stick to the body 2 of the cleaning and conditioning cloth. In a first embodiment, the oil square is first covered with a layer of contact adhesive on a first side, and then impregnated with oil on the opposite side. The side with the contact adhesive is then adhered to the body of the blade wiper.

In an alternative embodiment if the oil square 4 is made from the same material as body 2, it can simply be part of body 2. In this case, the body 2 is back coated with oil impermeable material, such as plastic sheet, to prevent oil from penetrating to the other side.

In a further embodiment a boundary square, which is a second piece of material having the same dimensions as the oil square, but impermeable to oil, is first permanently affixed to the oil square before the application of any oil. Then contact adhesive is applied to the boundary square, and oil is applied to the oil square. The oil square is finally affixed to the cleaning and conditioning cloth body.

In use, the cleaning and conditioning cloth is held in one hand and the ice skate in the other, as may be seen in FIG. 4. The blade of the ice skate is placed in the middle of the oil square, and the ice skate and or the cleaning and conditioning cloth are moved relative to each other, so that the blade moves from the cleaning and conditioning cloth body to the oil square. In this way the water is first removed from the blade by the cleaning and conditioning cloth body, and then the oil is applied by the oil square. The user lifts the blade away from the cleaning and conditioning cloth as it moves away from the oil square, so that the oil is not removed from the blade once it is applied.

In the first embodiment the cleaning and conditioning cloth is discarded or collected for recycling after each use as the contact adhesive is of a kind which allows the oil square to be peeled off from the cleaning and conditioning cloth body once it is depleted of oil. However, body 2 can be re-used if not dirty or wet. Thus, a user may have a supply of oil squares, already impregnated with oil, to be used with a single, re-usable cleaning and conditioning cloth body.

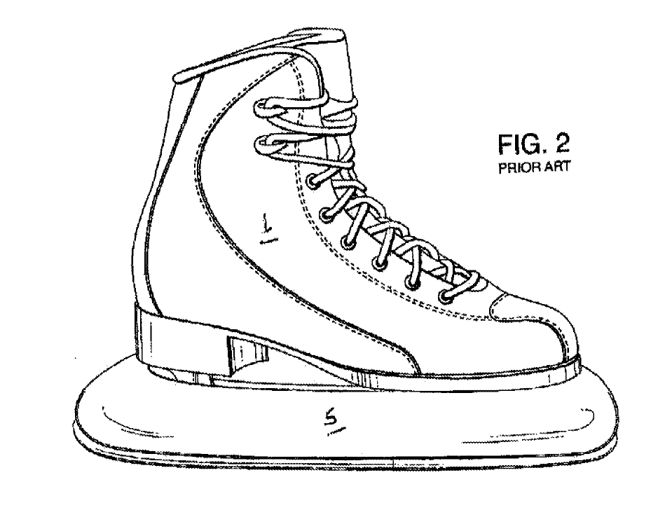

Finally, the ice skate blade may be inserted into a covering similar to the “soaker” shown in FIG. 2, in order to prevent the oil on the ice skate blade from soiling the user's clothing, car seat, etc. This covering should have an outer surface which is impermeable to the oil used in the cleaning and conditioning cloth.

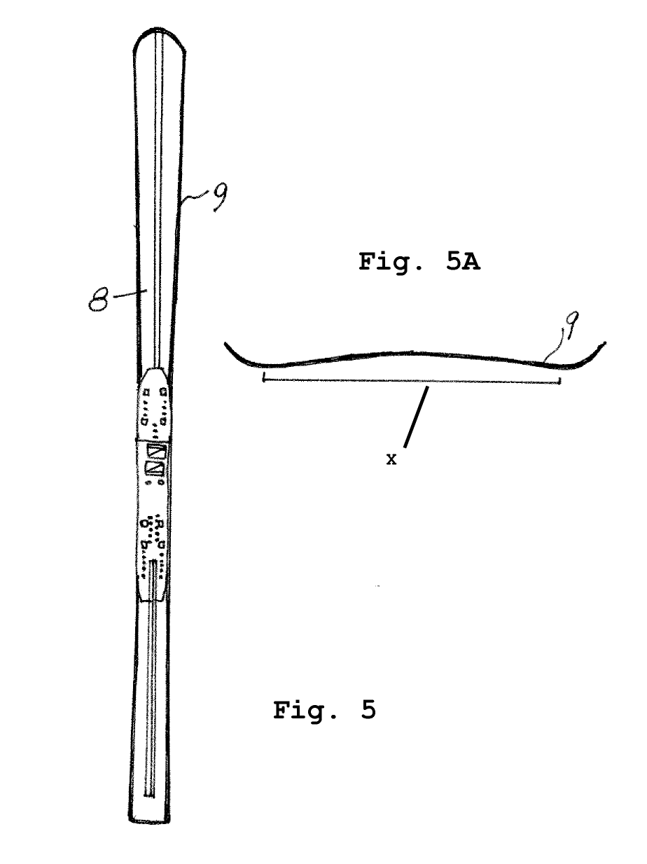

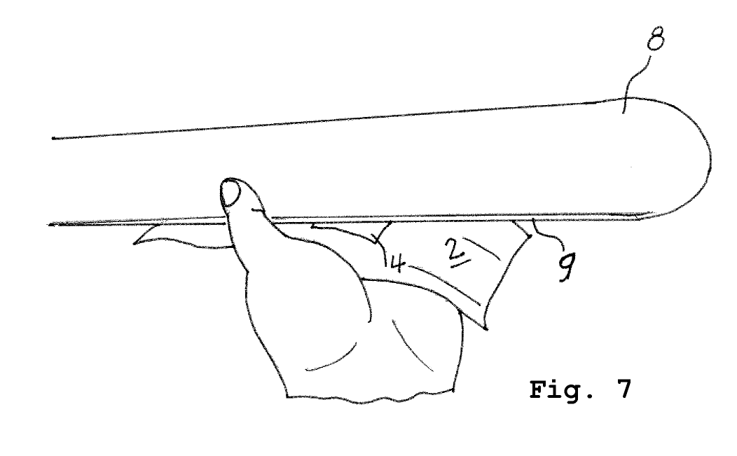

An alternative embodiment may be understood by referring now to FIGS. 5, 5A, and 7. These figures depict a ski 8, and further show the cleaning cloth being used to clean the metallic edges 9 of the ski. The ski edge bears some similarity in that both are made of metal, both are sharp, and both are subject to corrosion. Thus the ski edge 9 should benefit equally from cleaning by the present cleaning cloth, as depicted in FIG. 7. After the ski is removed at the end of the skiing activity, the user places the cloth in the palm of the hand, and wipes the moisture off with the un-oiled portion of the cloth. Then, as shown in FIG. 7, the user wipes the now-dried edge of the ski with the oiled or waxed portion 4 of the cloth, thus preserving the metal service against corrosion.

Other objects with sharp metal edges also benefit from cleaning with the cleaning cloth as described herein. These objects include knives, snow boards, and sled runners. Even objects without sharp edges, such as fishing rods, guns and golf clubs, benefit from cleaning with this device.

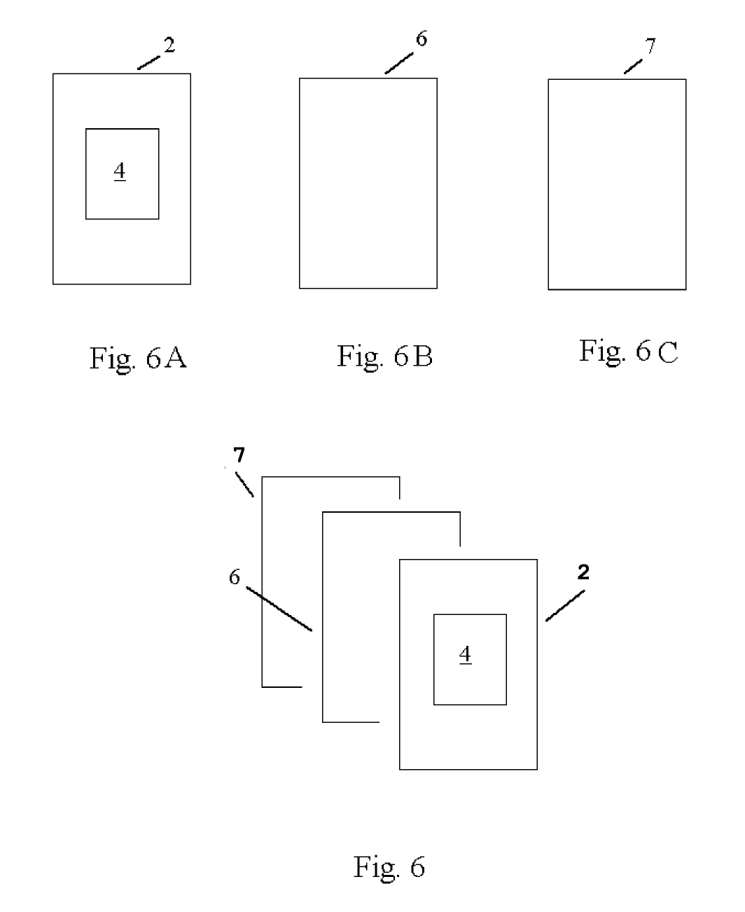

A still further embodiment of the cleaning cloth may be understood by referring now to FIGS. 6, 6A, 6B, and 6C. These figures show the cloth constructed of three different layers. FIG. 6A shows the second layer 2, which contains the oiled central portion 4, or oil square, similar to the construction of the first embodiment. The first layer 7, appearing in FIG. 6C, is made of an material which absorbs moisture as well as oil. And the third layer 6, as shown in FIG. 6B, is made of an impervious material which prevents the oil in the first layer from contaminating the second layer with oil from the first layer.

In its final construction, the three layers are laminated together into a single cloth, as shown in the exploded drawing of FIG. 6.

In practice, the method of using the three-layer embodiment is somewhat different from that of the first embodiment, in that the user may turn the cloth into a position where the second, absorbent layer is used to wipe an area of the object dry, and then the cloth is turned over to apply the oil to the object.

The three-layer embodiment may be manufactured by affixing the oiled central area portion to the cloth after the three layers have been laminated together. Alternatively, the oil may be applied to the central area after all the laminations have taken place, and the central area portion has already been affixed to the cloth.

It should also be obvious that the user may wish to use gloves while handling the cloth, to keep the oil away from the user's skin.

In all of the foregoing descriptions, the word “oil” should be understood to include various types of lubricating substances, including waxes.

While various aspects of the device and method have been set forth by the drawings and specification, it is to be understood that the foregoing detailed description is for illustration only and that various changes in parts, as well as the substitution of equivalent constituents for those shown and described may be made without departing from the spirit and scope of the device and method as set forth in the appended claims.

1. A cleaning and conditioning cloth comprising:
a) a body of cut-resistant, non-abrasive, low lint, water-absorbent and oil-absorbent material, and
b) a piece of oil-impregnated fabric, affixed to the approximate center of the body.

2. The cleaning and conditioning cloth of claim 1, wherein the piece of oil-impregnated fabric may be removed from the body, and another piece of oil-impregnated fabric may be removably affixed to the center of the rectangular body.

3. The cleaning and conditioning cloth of claim 1 wherein the oil used is selected from a group which consists of vegetable oil, natural oil, synthetic oil, semi-synthetic oil and wax.

4. The cleaning and conditioning cloth of claim 2 wherein the oil used is selected from a group which consists of vegetable oil, natural oil, synthetic oil, semi-oil and wax.

5. A cleaning and conditioning cloth comprising:
a) a first layer comprising a cut-resistant, non-abrasive, low lint, water-absorbent and oil-absorbent material;
b) a second layer comprising oil-embedded material; and
c) a third layer, disposed between the first and second layers, comprised of a material that prevents contamination between the first and second layers, wherein the third layer is affixed on one surface to the first layer, and on an opposite surface to the second layer, forming a single cloth thereby.

6. The cleaning and conditioning cloth of claim 5 wherein the oil used is selected from a group which consists of vegetable oil, natural oil, synthetic oil, semi-synthetic oil and wax.

7. The cleaning and conditioning cloth of claim 1, wherein the piece of oil-impregnated fabric may be removed from the rectangular body, and another piece of oil-impregnated fabric may be removably affixed to the center of the rectangular body.

8. A method of cleaning comprising the following steps:
(a) creating a cleaning and conditioning cloth, the cloth comprising:
i) a first side, comprising a body of cut-resistant, non-abrasive, low lint, water-absorbent and oil-absorbent material, and
ii) a piece of oil-impregnated fabric, affixed to the approximate center of a second side of the body;
(b) wiping an object to be cleaned on the first side of the cleaning and conditioning cloth; and
(c) applying oil to the object by wiping it with the oil-impregnated fabric.

9. A method of cleaning comprising the following steps:
(a) creating a cleaning and conditioning cloth, the cloth comprising:
i) a first layer comprising a cut-resistant, non-abrasive, low lint, water-absorbent and oil-absorbent material;
ii) a second layer comprising oil-embedded material; and
iii) a third layer, disposed between the first and second layers, comprised of a material that prevents contamination between the first and second layers, wherein the third layer is affixed on one surface to the first layer, and on an opposite surface to the second layer, forming a single cloth thereby,
(b) wiping an object to be cleaned on the first layer of the cleaning and conditioning cloth; and
(c) applying oil to the object by wiping it with the second layer.

10. The method of claim 8, wherein the piece of oil-impregnated fabric may be removed from the body, and another piece of oil-impregnated fabric may be removably affixed to the center of the rectangular body.

11. The method of claim 10 wherein the oil used is selected from a group which consists of vegetable oil, natural oil, synthetic oil, semi-synthetic oil and wax.

12. The method of claim 11, further comprising cleaning any one of the members of a group which consists of ice skate blades, ski edges, snow board edges, sled runners, knives, fishing rods, guns and golf clubs.

13. The method of claim 9 wherein the oil used is selected from a group which consists of vegetable oil, natural oil, synthetic oil, semi-synthetic oil and wax.

14. The method of claim 13, further comprising cleaning any one of the members of a group which consists of ice skate blades, ski edges, snow board edges, sled runners, knives, fishing rods, guns and golf clubs.
